(19) United States
(12) Patent Application Publication
(10) Pub. No.: US 2006/0138765 A1
(43) Pub. Date: Jun. 29, 2006

(54) Filing folder with at least two flaps for documents

(76) Inventor: Christophe Pierre Antoine Marie Girard, Douvres La Delivrande (FR)

Correspondence Address: LEYDIG VOIT & MAYER, LTD, 700 THIRTEENTH ST. NW, SUITE 300, WASHINGTON, DC, 20005-3960, US

(21) Appl. No.: 10/539,408

(22) PCT Filed: Dec. 1, 2003
(86) PCT No.: PCT/FR03/03544

§ 371 Date: Feb. 14, 2006

(30) Foreign Application Priority Data
Nov. 29, 2002 (FR) 02/15044

(51) Int. Cl. B42D 1/00

(52) U.S. Cl. 281/21.1

(57) ABSTRACT

A document folder including two sheets joined by a binding. One of the sheets has at least two flaps. Note book pages are securely linked to the binding. The note book pages are stored by folding the flaps successively one on top of the other on the sheet with the pages beneath the flaps folded towards the sheet.

The present invention relates to a document filing folder with at least two flaps.

There is a known folder of this type which has a cover formed by two sheets, an anterior sheet and a posterior sheet, which are assembled together by a binding generally made up of a folded zone, the posterior sheet having at least two flaps situated respectively along one of the lower or upper edges and its right or lateral edge. The flaps can be folded down towards the interior of the posterior sheet for storing the documents found in the folder.

The disadvantage of such a folder is that the documents, generally in the form of sheets of paper, are often filed in a disordered manner, and certain of these documents can become lost during their handling.

The present invention aims to eliminate the above disadvantage of the known filing folders by proposing a document filing folder with at least two flaps, which has a cover formed by two sheets, an anterior sheet and a posterior sheet, which are assembled together by a binding, one of the sheets having a flap along at least one of its lower and upper edges and another flap along its lateral edge, which can be folded down towards the interior of the sheet for storing the documents found in the folder, and which is characterized by the fact that the documents consist of notebook pages, securely linked to the binding of the two sheets so that the pages can be stored by folding them down successively, one on top of the other, on the sheet and under the flaps folded towards this sheet.

Preferably, the sheet with the flaps is the posterior sheet.

Advantageously, the binding is of the spiral type enabling the notebook pages to be stored flat on the sheet with flaps.

The folder can be closed by at least one closing means consisting of a rubber band, which is attached to the anterior or posterior sheet by rivets or the like while sliding relative to the sheet through eyelets, and which can be turned down over at least one of the two corners of the opposite sheet or all in one piece over this sheet, parallel to the binding.

The anterior or posterior sheet has three respective flaps, along the lower and upper edges, and along the lateral edge of the sheet.

The invention will be better understood, and other aims, characteristics, details and advantages of it will appear more clearly in the following explanatory description with reference to the appended drawings, given only by way of example illustrating an embodiment of the invention, and in which:

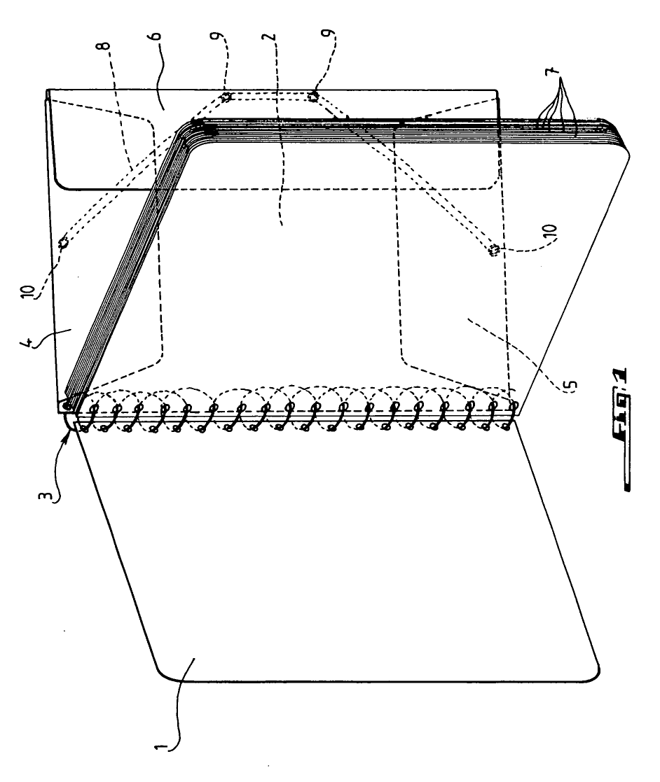

FIG. 1 is an oblique view of a filing folder of the invention in open position;

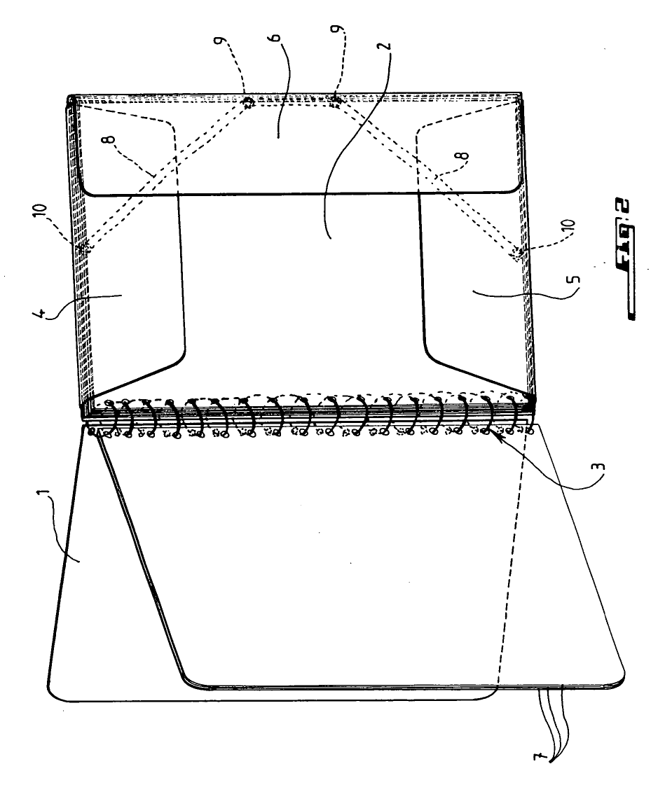

FIG. 2 is an oblique view of the folder of FIG. 1 in another open position;

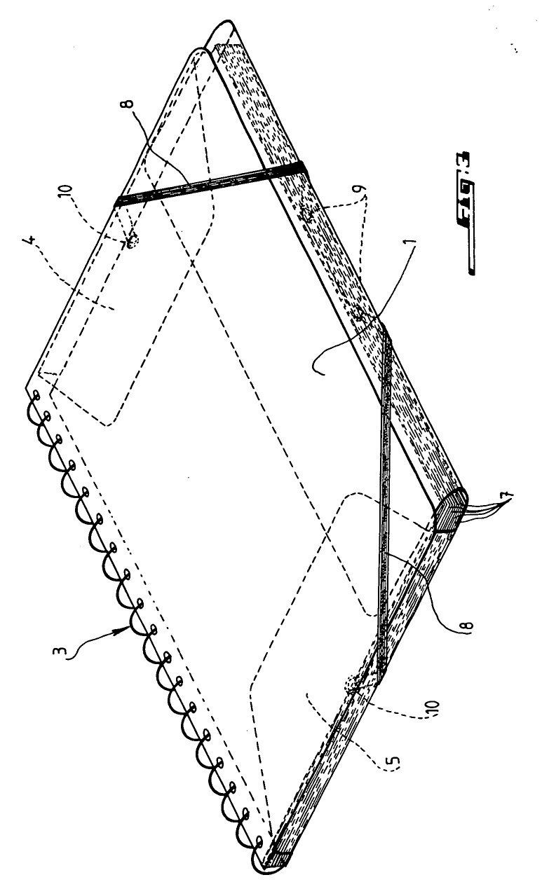

FIG. 3 is an oblique view representing the folder closed.

In reference to the figures, the filing folder has a cover formed by an anterior sheet and posterior sheet 2 connected to anterior sheet 1 by binding 3.

Posterior sheet 2 has three flaps 4, 5, 6, respectively along its upper edge, lower edge and right or lateral edge, and which can be folded down towards the interior of sheet 2 so as to receive and store documents 7 in the housing defined by sheet 2 and its flaps 4 to 6.

The folder can be closed by a closing means consisting in this case of rubber band 8 which is mounted so as to slide on the dorsal side of posterior sheet 2 through two eyelets 9 and which is attached at its ends to posterior sheet 2 by two rivets 10 or by any other means for immobilization or attachment, so as to close anterior sheet 1 in folded-down position over flaps 4 to 6 by engagement of the rubber band over the two corners of the folder on the anterior sheet. Thus, for rubber bands folded parallel to flap 6, the immobilization will be brought about by a metallic anti-return pin. Of course, rubber band 8 for closing can be attached in the same manner to anterior sheet 1 and mounted so as to slide to close the folder by turning the rubber band down over the opposite corners on the dorsal side of sheet 2. The rubber band can also be attached to either of sheets 1, 2 so as to close the folder by turning the band down over the corresponding sheet along a direction essentially parallel to the binding.

According to the invention, documents 7 consist of notebook pages securely linked to binding 3 of sheets 1, 2 so as to enable pages 7 to be stored by folding these pages down successively, one on top of the other, in the housing defined by sheet 2 and flaps 4 to 6 folded over it.

Preferably, the binding is formed by spirals assembling sheets 1, 2 and documents 7 together through corresponding perforations such that each notebook page 7 can be stored in the folder completely flat over sheet 2. Spirals do not necessarily pertain to a single spiral wire, but can also pertain to a double wire in each perforation of the sheets.

Thus, the user can store the various notebook sheets 7 in the folder in an ordered manner and without losing them. Furthermore, it is possible for him to divide documents 7 into two parts, storing those of a first part in the housing between sheet 2 and flaps 4 to 6, and arranging the upper part of the remaining documents over flaps 4 to 6, and then closing the folder, constituting a sort of indexing. This can be useful in order to allow a user to resume work later at the place where it was left off.

Sheets 1, 2 and flaps 4 to 6 can be produced out of any appropriate material, such as cardboard, plastic material, translucent or not, and of any appropriate color.

Furthermore, flaps 4 to 6, instead of being part of posterior sheet 2, can be formed respectively along the upper and lower edges and the right or lateral edge of anterior sheet 1 without diverging from the scope of the present invention.

It is possible for the folder to have only two flaps, one flap present along the lower edge of anterior sheet 1 or of posterior sheet 2 and one flap along the lateral edge of this sheet. Advantageously, it is possible to house loose documents in the cover with flaps, that is to say documents not connected to the binding, and accessories such as pens, a calculator or other accessories.

1. A document filing folder comprising:
a cover including an anterior sheet and a posterior sheet, a binding joining the anterior and posterior sheets, one of the anterior and posterior sheets having a first flap along at least one of lower and upper edges and a second flap along a lateral edge, the flaps being foldable towards an interior side of the sheet for storing documents, the documents being notebook pages securely linked to the binding for storing the notebook pages by folding the flaps successively, one on top of another, toward the sheet, with the notebook pages stored under the flaps folded towards the sheet.

2. The filing folder according to claim 1, wherein the sheet with the flaps is the posterior sheet.

3. The filing folder according to claim 1, wherein the binding includes a spiral, enabling the notebook pages to be stored flat over the sheet with the flaps.

4. The filing folder according to claim 1, comprising closing means including a rubber band attached to one of the anterior sheet and the posterior sheet, sliding relative to the sheet through eyelets, and which can be placed over at least one a corner of the other sheet and the sheet, parallel to the binding.

5. The filing folder according to claim 1, wherein one of the anterior sheet and the posterior sheet has three flaps, respectively along the lower and upper edges, and along the lateral edge.

6. The filing folder according to claim 2, wherein the binding includes a spiral, enabling the notebook pages to be stored flat over the sheet with the flaps.

7. The filing folder according to claim 2, comprising closing means including a rubber band attached to one of the anterior sheet and the posterior sheet, sliding relative to the sheet through eyelets, and which can be placed over at least one a corner of the other sheet and the sheet, parallel to the binding.

8. The filing folder according to claim 3, comprising closing means including a rubber band attached to one of the anterior sheet and the posterior sheet, sliding relative to the sheet through eyelets, and which can be placed over at least one a corner of the other sheet and the sheet, parallel to the binding.

9. The filing folder according to claim 2, wherein one of the anterior sheet and the posterior sheet has three flaps, respectively along the lower and upper edges, and along the lateral edge.

10. The filing folder according to claim 3, wherein one of the anterior sheet and the posterior sheet has three flaps, respectively along the lower and upper edges, and along the lateral edge.

11. The filing folder according to claim 4, wherein one of the anterior sheet and the posterior sheet has three flaps, respectively along the lower and upper edges, and along the lateral edge.
